(19) United States
(12) Patent Application Publication
(10) Pub. No.: US 2022/0306247 A1
(43) Pub. Date: Sep. 29, 2022

(54) CARGO NET SYSTEM AND METHODS OF USE

(71) Applicant: John Lee, Porterville, CA (US)

(72) Inventor: John Lee, Porterville, CA (US)

(21) Appl. No.: 17/684,411

(22) Filed: Mar. 1, 2022

Related U.S. Application Data
(63) Continuation-in-part of application No. 29/775,890, filed on Mar. 25, 2021, now Pat. No. D944718.

(51) Int. Cl. B63B 25/24; B63B 25/00

(52) U.S. Cl. CPC B63B 25/24; B63B 25/002

(57) ABSTRACT

The present invention relates to a portable and removable cargo net system operable to be installed in compartments or spaces of varying sizes in a vehicle such as a boat. The cargo net may be used to separate cargo from other structures in the cargo space or compartment to (1) prevent damage to the cargo or other structures in the cargo compartment or space and/or (2) to maintain ordered arrangement of the cargo held in the cargo net.

### FIELD OF THE INVENTION

The present invention relates to cargo net systems, and more specifically to a portable and removable cargo net system for removable placement in cargo compartments. Embodiments of the present invention are useful for stowing and transporting cargo in a vehicle.

### DISCUSSION OF THE BACKGROUND

Vehicle storage nets are typically used to prevent movement of and damage to stowed item(s) and to prevent the stowed item(s) from causing damage to other items which may be typically carried in a storage area or compartment, for example, the trunk of a car or a stowage in a boat.

Conventional vehicle storage nets have a number of disadvantages. For example, some conventional vehicle storage nets and devices are permanently attached to the cargo compartment of a vehicle. As such, these nets and devices are not removable from the vehicle for transporting the items stowed in the devices. Such permanent installation results in a committed area of the cargo compartment or other portion of the vehicle, limiting the versatility of the cargo space.

Therefore, what is needed is a cargo net system for stowing items that can be removed and installed as needed that can accommodate compartments of different sizes.

### SUMMARY OF THE INVENTION

The present invention relates to a portable and removable cargo net system operable to be installed in compartments or spaces of varying sizes in a vehicle such as a boat. The cargo net may be used to separate cargo from other structures in the cargo space or compartment to (1) prevent damage to the cargo or other structures in the cargo compartment or space and/or (2) to maintain ordered arrangement of the cargo held in the cargo net. For example, boats include many storage compartments that can house functional items, such as ballast containers, engine repair kits, replacement parts, fuel tanks, mooring devices, etc. (“functional boat equipment”) that do not occupy the entire compartment. The cargo net system of the present invention is adaptable to compartments of various sizes that may have usable room over functional boat equipment. It is desirable to store other items, such as life vests, towels, swim gear, food, etc. and keep them separated from such functional boat equipment.

The cargo net system comprises a net structure having a plurality of criss-crossing strap members. A plurality of the strap members may have extensions that each include a plurality of receiver loops operable to pass a mounting rod. The receiver loops of adjacent extensions may be aligned in multiple rows such that the mounting rod can be passed through adjacent extensions easily. The plurality of receiver loops are positioned at varying distances from the out edge of the net to allow the cargo net to be mounted in compartments of varying sizes.

The cargo net system may further comprise mounting devices (e.g., mounting clips) that can be installed on the interior of a compartment or in another area in which cargo can be stored with at least two substantially parallel walls. The mounting devices may be attached to the wall of a compartment by various fasteners, such as screws, pins, adhesives, or other fasteners. The mounting rod may be engaged with the receiver loops and subsequently engaged with the mounting devices installed in the compartment or other cargo area to provide a suspended cargo net operable to store items with separation from other items and objects in the cargo compartment or storage area. The mounting rod connection with the mounting devices may be a reversible connection such as a snap fit connection, a mechanical latch, a ball lock pin mechanism, or other compact locking mechanism. The mounting rods can be easily engaged with the mounting devices and removed from the mounting devices. The mounting rods and cargo net can be used as a sling to carry the cargo in the cargo net when the mounting rods are removed from the mounting devices. Thus, the cargo net system improves the portability of the items stored in the cargo net, allowing them to be removed from the cargo compartment or area collectively in the cargo net in one effort.

The cargo net can easily be adjusted to fit in oddly shaped cargo compartments or areas to accommodate the available storage spaces. The cargo net can set to difference widths and tensions between the mounting brackets without the use of any cinching devices. The width and/or tension of the cargo net can be adjusted by positioning the rods in different rows of receiver loops. The tension may be adjusted to control the sag in the cargo net. If the compartment in which the cargo net system is situated is substantially full, the tension in the cargo net can be increased and sag reduced by moving the mounting rods into rows of receiver loops that are closer to the cargo net mesh.

The straps of the cargo net may comprise a durable material operable to suspend significant weight (e.g., up to 500 lbs), such as nylon, carbon fiber, fiberglass, poly vinyl chloride (PVC) coated polyester, or other high tensile strength materials. The extensions that extend from the cargo net may include the same material as the cargo net straps or another high tensile strength material. The cargo net may be a criss-crossing pattern of straps with gaps between the straps each having an area in a range of about one cm² to about 25 cm². In some embodiments, the cargo net may be a mesh material with high tensile strength. The cargo net of the present system of the present invention is advantageously lightweight, strong and easy to use.

Further objects and aspects of the present invention will be apparent from the description provided herein.

### BRIEF DESCRIPTION OF THE DRAWINGS

FIG. 1 shows a perspective view of a cargo net system according to an embodiment of the present invention.

FIG. 2 shows a top-down view of a cargo net system according to an embodiment of the present invention.

FIG. 3 shows a bottom-up view of a cargo net system according to an embodiment of the present invention.

FIG. 4 shows a first side view of a cargo net system according to an embodiment of the present invention.

FIG. 5 shows a second side view of a cargo net system according to an embodiment of the present invention.

FIG. 6 shows a first end view of a cargo net system according to an embodiment of the present invention.

FIG. 7 shows a second end view of a cargo net system according to an embodiment of the present invention.

FIG. 8 shows the process of inserting a mounting rod into mounting devices according to an embodiment of the present invention.

FIG. 9 shows the process of inserting a mounting rod being inserted through a row of receiver loops according to an embodiment of the present invention.

FIG. 10 shows an environment view of the cargo net system installed in a cargo compartment according to an embodiment of the present invention.

### DETAILED DESCRIPTION OF THE DRAWINGS

Reference will now be made in detail to certain embodiments of the invention, examples of which are illustrated in the accompanying drawings. While the invention will be described in reference to these figures and certain implementations and examples of the embodiments, it will be understood that such implementations and examples are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. References to various features of the “present invention” throughout this document do not mean that all claimed embodiments or methods must include the referenced features. It will be apparent to one skilled in the art that the present invention may be practiced without these specific details or features.

Reference will be made to the exemplary illustrations in the accompanying drawings, and like reference characters may be used to designate like or corresponding parts throughout the several views of the drawings.

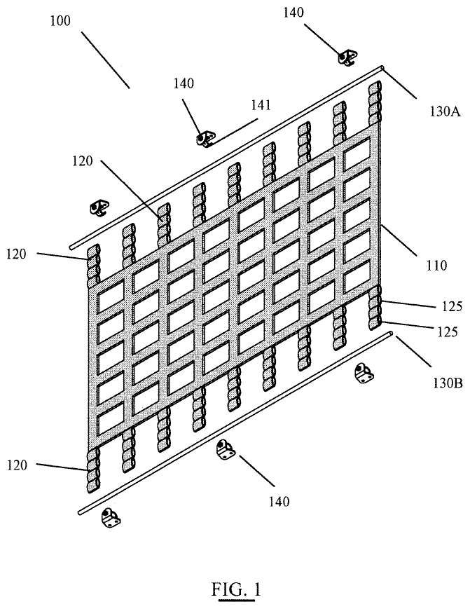

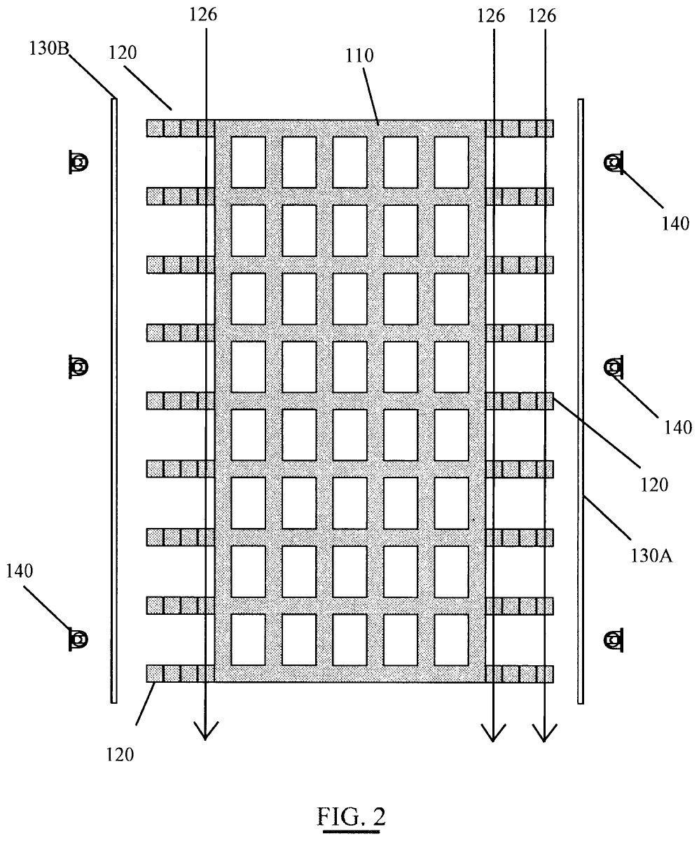

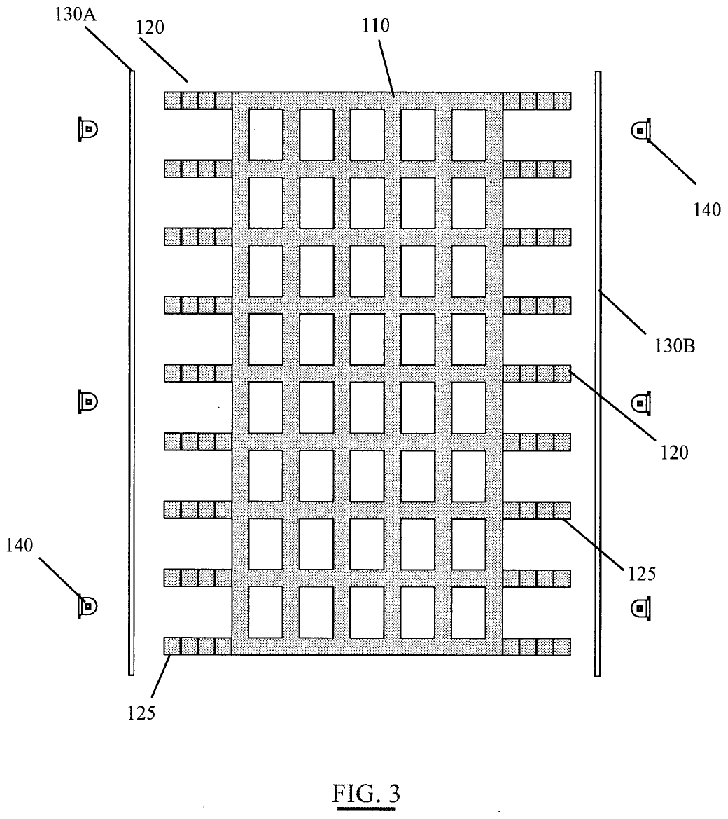

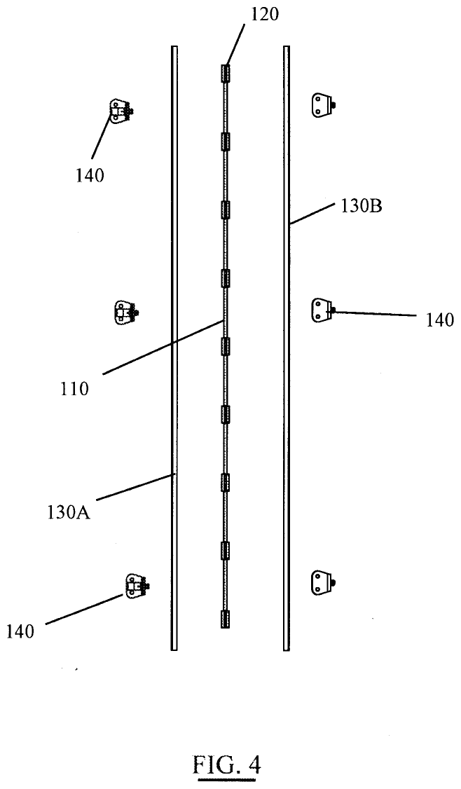

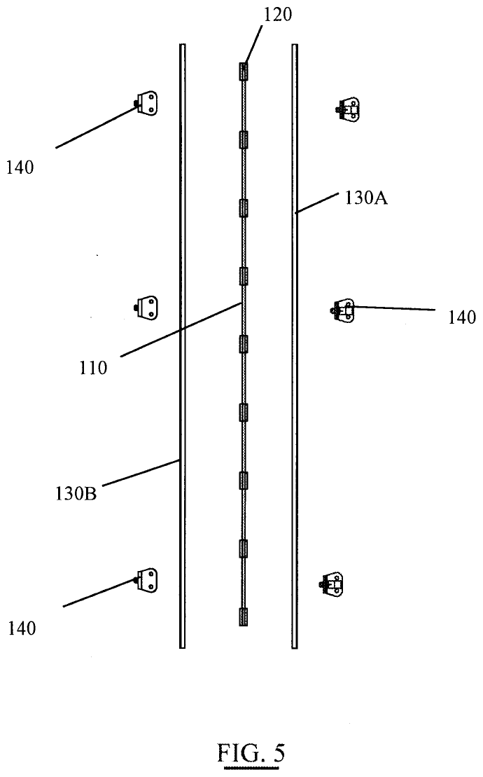

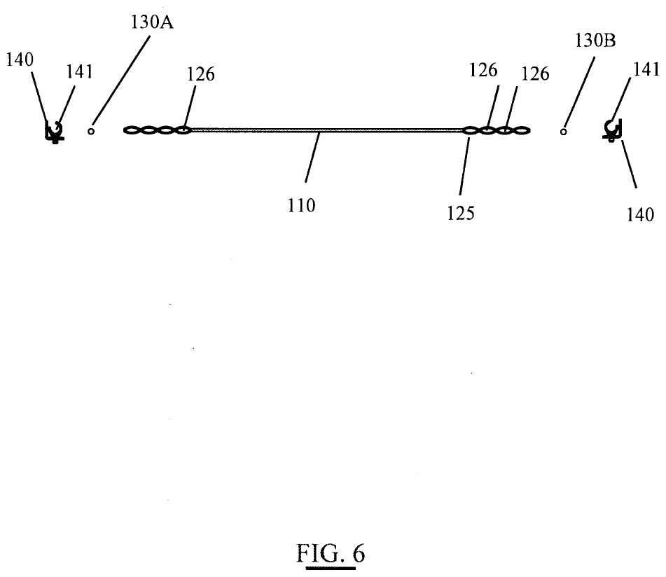

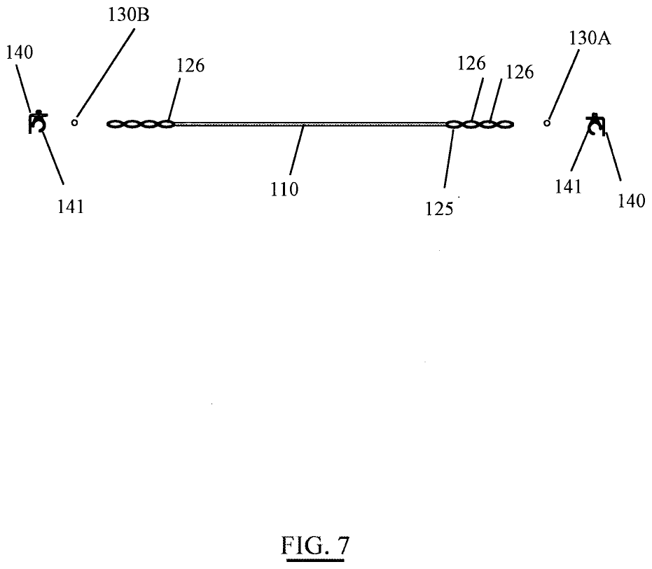

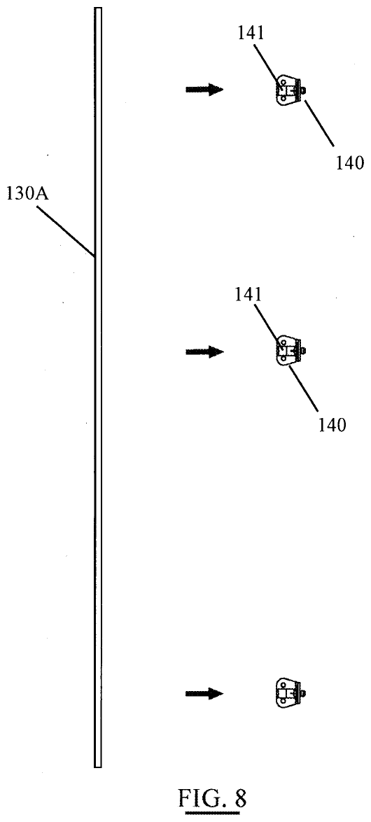

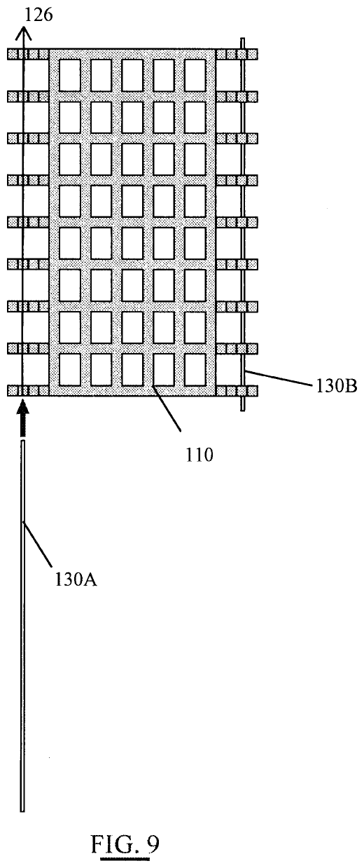

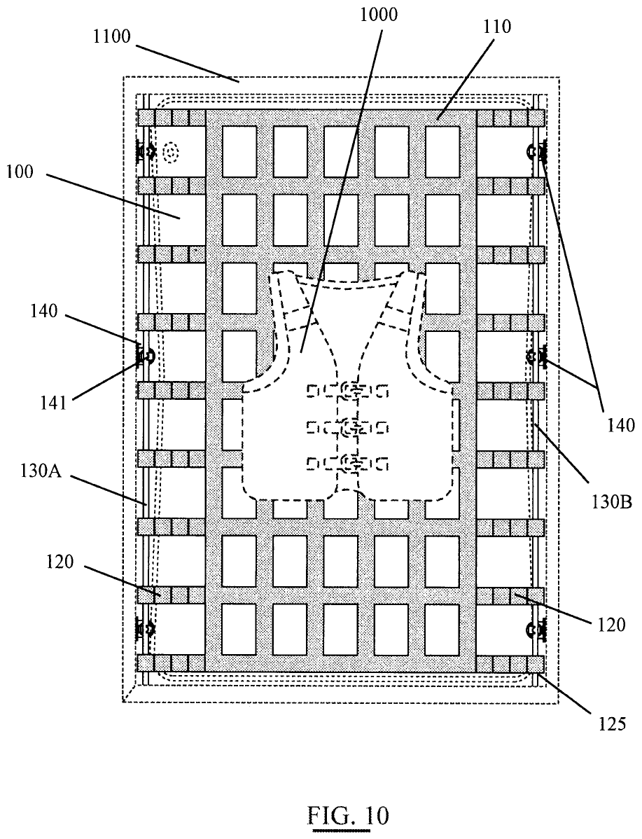

As seen in FIGS. 1-10, the present invention provides a cargo net system 100 for securing cargo 1000 in a cargo compartment 1100 in a vehicle (e.g., a boat) or in a cargo area. The cargo net system 100 may comprise a cargo net 110, mounting rods 130A and 130B, receiver extensions 120, receiver loops 125 for receiving the mounting rods 130A and 130B, receiver loop rows 126, and mounting devices 140 for installation in the cargo compartment 1100 (or other cargo area) and to support mounting rods 130A and 130B.

The cargo net system 100 comprises a net structure 110 having a plurality of criss-crossing strap members 111. A plurality of the strap members 111 may have receiver extensions 120 that extend substantially orthogonally from the outer edge of the cargo net 110. Each receiver extension 120 may include a plurality of receiver loops 125 operable to pass a mounting rod 130A or 130B. The receiver loops 125 of adjacent extensions 120 may be aligned in multiple rows 126 such that the mounting rod can be passed through adjacent extensions easily. The receiver loop rows 126 provide different positionings of the mounting rods 130A and 130B at different distances from the outer edge of the cargo net 110 on each side of the cargo net 110. The plurality of receiver loops 125 are positioned at varying distances from the out edge of the net 110 to allow the cargo net to be mounted in compartments of varying sizes.

The cargo net system 100 may further comprise mounting devices 140 (e.g., mounting clips) that can be installed on the interior of a compartment 1100 or in another area in which cargo 1000 can be stored with at least two substantially parallel walls. The mounting devices 140 may be attached to the wall of a compartment by various fasteners, such as screws, pins, adhesives, or other fasteners. The mounting rods 130A and 130B may be engaged with the receiver loops 125 and subsequently engaged with the mounting devices 140 installed in the compartment 1100 (or other cargo area) to provide a suspended cargo net 110 operable to store cargo 1000 with separation from other items and objects in the cargo compartment 1100. The mounting rods 130A and 130B reversibly connect with the mounting devices 140 in a pressure or snap fit manner at cylindrical clasps 141. In other embodiments, the mechanical connection between the mounting rods 130A and 130B and the mounting devices may be a mechanical latch, a ball lock pin mechanism, or other compact locking mechanism. The mounting rods 130A and 130B can be easily engaged with the mounting devices 140 and removed from the mounting devices 140.

The mounting rods 130A and 130B and cargo net 110 can be used as a sling to carry the cargo 1100 in the cargo net 110 when the mounting rods 130A and 130B are removed from the mounting devices 140. Thus, the cargo net system 100 improves the portability of the items stored in the cargo net 110, allowing them to be removed from the cargo compartment 1100 in the cargo net 110 in one effort.

The cargo net 110 can easily be adjusted to different widths and tensions between the mounting devices 140 without the use of any cinching devices. The width and/or tension of the cargo net 110 can be adjusted by positioning the rods 130A and 130B in different rows 126 of receiver loops 125. The tension may be adjusted to control the sag in the cargo net 110. If the compartment 1100 in which the cargo net system 100 is situated is substantially full, the tension in the cargo net 110 can be increased and sag reduced by moving the mounting rods 130A and 130B into rows 126 of receiver loops 125 that are closer to the cargo net mesh.

The straps of the cargo net 110 may comprise a durable material such as nylon, carbon fiber, fiberglass, poly vinyl chloride (PVC) coated polyester, or other high tensile strength materials. The adjacent extensions 120 that extend from the cargo net 110 may include the same material as the cargo net straps 111 or another high tensile strength material. The cargo net 110 may be a criss-crossing pattern of straps 111 with gaps between the straps each having an area in a range of about one cm² to about 25 cm².

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed:

1. A cargo net system for securing cargo, comprising:
a. a cargo net having an outer perimeter;
b. a plurality of extensions at said outer perimeter, each of said extensions comprising a plurality of receiver slots;
c. at least one mounting rod operable to be inserted through any of said plurality of receiver slots in each of said plurality of extensions; and
d. at least one mounting device having a fastening mechanism for engaging with said at least one mounting rod.

2. The system of claim 1, wherein said cargo net includes a first plurality of extensions on a first side of the cargo net and a second plurality of extensions on a second side of the cargo net.

3. The system of claim 1, wherein each of said plurality of extensions includes at least three receiver slots.

4. The system of claim 1, wherein the plurality of receiver slots in each of said plurality of extensions align.

5. The system of claim 4, wherein the each of the plurality of receiver slots are parallel with an edge of the cargo net from which the extension protrudes.

6. The system of claim 1, wherein the at least one mounting device includes a pressure fitting portion operable to reversibly engage said mounting rod.

7. The system of claim 1, wherein the at least one mounting rod includes a first mounting rod and a second mounting rod, the at least one mounting device includes a first plurality of mounting devices and second plurality of mounting devices, wherein said first plurality of mounting devices are installed on a first wall and said second plurality of mounting devices are installed on a second wall and said first mounting rod is reversibly engaged with the first plurality of mounting devices and said second mounting rod is reversibly engaged with said second plurality of mounting devices.

8. A cargo net system for securing cargo, comprising:
a. a cargo net having an outer perimeter;
b. a plurality of extensions at said outer perimeter, each of said extensions comprising a plurality of receiver slots; and
c. at least one mounting rod operable to be inserted through any of said plurality of receiver slots in each of said plurality of extensions.

9. The system of claim 8, wherein said cargo net includes a first plurality of extensions on a first side of the cargo net and a second plurality of extensions on a second side of the cargo net.

10. The system of claim 8, wherein each of said plurality of extensions includes at least three receiver slots.

11. The system of claim 8, wherein the plurality of receiver slots in each of said plurality of extensions align.

12. The system of claim 11, wherein the each of the plurality of receiver slots are parallel with an edge of the cargo net from which the extension protrudes.

13. The system of claim 8, wherein the at least one mounting device includes a pressure fitting portion operable to reversibly engage said mounting rod.

14. The system of claim 8, further comprising a first plurality of mounting devices and a second plurality of mounting devices, wherein said first plurality of mounting devices are installed on a first wall and said second plurality of mounting devices are installed on a second wall, wherein the at least one mounting rod includes a first mounting rod reversibly engaged with the first plurality of mounting devices and a second mounting rod reversibly engaged with said second plurality of mounting devices.

15. A method of utilizing a cargo net system for securing cargo, comprising:
a. installing a first plurality of mounting devices in a first surface and installing a second plurality of mounting devices in a second surface;
b. inserting a first mounting rod through a plurality of receiver slots, wherein said first plurality of receiver slots are aligned and are formed in a first plurality of parallel extensions that protrude orthogonally from a first side of a cargo net;
c. inserting a second mounting rod through a second plurality of receiver slots, wherein said second plurality of receiver slots are aligned and are formed in a second plurality of parallel extensions that protrude orthogonally from a second side of said cargo net;
d. inserting said first mounting rod in said first plurality of mounting devices; and
e. inserting said second mounting rod in said second plurality of mounting devices.

16. The method of claim 15, wherein each of said plurality of extensions includes at least three receiver slots.

17. The method of claim 15, wherein the plurality of receiver slots in each of said plurality of extensions align.

18. The method of claim 15, wherein the each of the plurality of receiver slots are parallel with an edge of the cargo net from which the extension protrudes.

19. The system of claim 15, wherein the mounting devices each include a pressure fitting portion operable to reversibly engage said mounting rod.
